(19) United States
(12) Patent Application Publication
(10) Pub. No.: US 2020/0265270 A1
(43) Pub. Date: Aug. 20, 2020

(54) MUTUAL NEIGHBORS

(71) Applicant: CASEWARE INTERNATIONAL INC., TORONTO (CA)

(72) Inventors: Cole BOUDREAU, TORONTO (CA); LEANNE MEZUMAN, HAMILTON (CA)

(21) Appl. No.: 16/280,690

(22) Filed: Feb. 20, 2019

(51) Int. Cl. G06K 9/62; G06F 17/18

(52) U.S. Cl. CPC G06K 9/6257; G06K 9/6259; G06K 9/6276; G06N 20/00; G06F 17/18; G06K 9/6218; G06K 9/6201

(57) ABSTRACT

Classification methods and systems label elements of a data set in order based on proximity to neighboring elements. An unlabeled data set is received, having data elements represented in a feature space. Elements from the data set are selected to represent clusters of elements. The selecting is based on proximity of the representative data elements to neighboring data elements within the feature space. Labels are assigned to the representative data elements. The labels are propagated by processing data elements in a sequence based on proximity. For each data element in the sequence, the label of the data element is propagated to its nearest neighbors.

### FIELD

This disclosure relates to computer-implemented methods and devices for performing data analysis and classification using proximity of data elements.

### BACKGROUND

Classification models are regularly used for classifying data elements of large data sets. Such classification models are traditionally initialized using a large set of labeled data (this process is referred to as “training”). Once trained, a classification model can be used to classify new data elements. However, obtaining a pre-labeled training data set may be impossible or extremely time consuming if the data set is large.

Systems, methods, and devices for efficient classification of data elements of large data sets may be desirable.

### SUMMARY

An example method for classifying data elements is executed by a processor coupled to a computer memory. The method comprises: receiving unlabeled data set, the unlabeled data set having a plurality of data elements, each represented in a feature space comprising a set of values corresponding to the features of the respective data element; selecting from the unlabeled data set, one or more representative data elements to represent corresponding clusters of data elements, the selecting based on proximity of the representative data elements to neighboring data elements within the feature space; labeling the representative data elements to identify the corresponding clusters; and for each one of a sequence of data elements, beginning with said representative data elements: selecting a labeled data element in the sequence; selecting unlabeled data elements neighboring that labeled data element; copying a label from that labeled data element to the selected unlabeled data elements; and adding the selected unlabeled data elements to the sequence.

An example computing system for classifying data elements comprises: a memory storing an unlabeled data set, the unlabeled data set having a plurality of data elements represented in a feature space, and storing executable instructions; and at least one processor configured to execute the executable instructions, the executable instructions causing the processor to: generate a labeled data set by: selecting from the unlabeled data set, one or more representative data elements to represent corresponding clusters of data elements, the selecting based on proximity of the representative data elements to neighboring data elements within the feature space; labeling the representative data elements to identify the corresponding clusters; and for each one of a sequence of data elements, beginning with said representative data elements: selecting a labeled data element in the sequence; selecting unlabeled data elements neighboring that labeled data element; copying a label from that labeled data element to the selected unlabeled data elements; and adding the selected unlabeled data elements to the sequence.

An example computing device comprises: a memory storing an unlabeled data set, the unlabeled data set having a plurality of data elements represented in a feature space; a data element selector to select one or more representative data elements to represent corresponding clusters of data elements, based on proximity of the representative data elements to neighboring data elements within the feature space from the unlabeled data set; a label generator to label the representative data elements to identify the corresponding clusters, and to propagate labels from labeled data elements in the data set to unlabeled data elements in the data set by, for each one of a sequence of data elements, beginning with said representative data elements: selecting a labeled data element in the sequence; selecting unlabeled data elements neighboring that labeled data element; copying a label from that labeled data element to the selected unlabeled data elements; and adding the selected unlabeled data elements to the sequence.

Other features will become apparent from the drawings in conjunction with the following description.

### BRIEF DESCRIPTION OF THE DRAWINGS

In the figures which illustrate example embodiments,

FIG. 1 is a network diagram illustrating a computer network and end-user computing devices connected to the network, exemplary of an embodiment;

FIG. 2 is a high level block diagram of a computing device of FIG. 1;

FIG. 3 illustrates example software organization of the computing device of FIG. 2;

FIG. 4 illustrates software modules of a classification tool of the computing device of FIG. 2;

FIGS. 5-6 illustrate flowcharts depicting exemplary blocks performed by the tool of the computing device of FIG. 2;

FIG. 7 is a plot of an example set of data elements in a feature space;

FIG. 8 is a table showing example data computed for each data element of the data set of FIG. 7;

FIG. 9 is a plot of the example data set of FIG. 7, with representative data elements identified;

FIG. 10 is a diagram showing a label propagation sequence for the data set of FIG. 7;

FIG. 11 is a table showing example labels applied to data elements of the data set of FIG. 7;

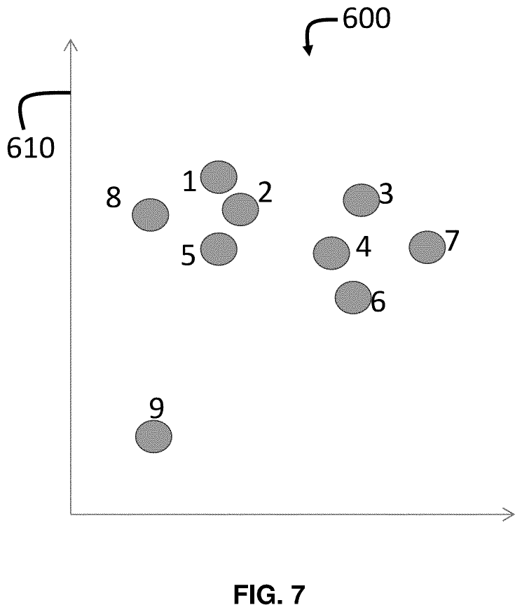

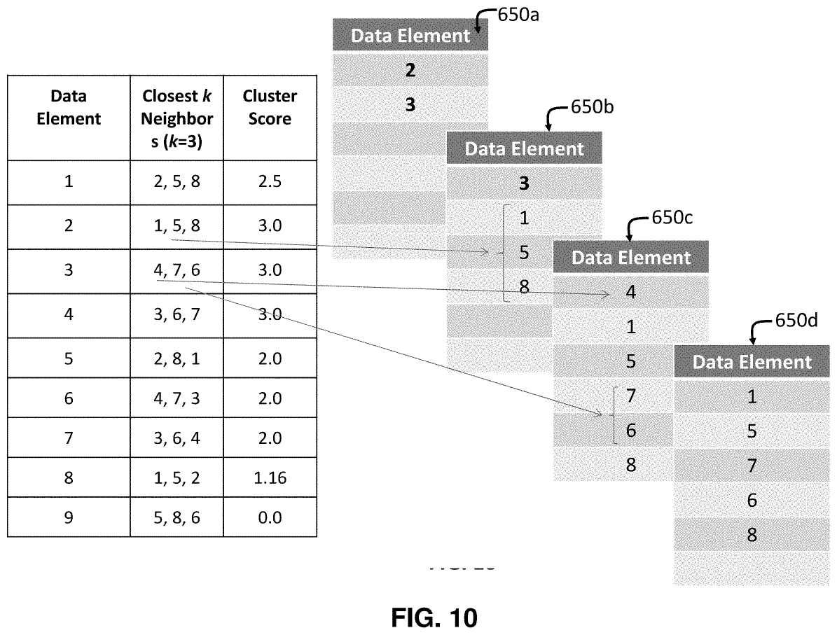

FIG. 9 is a plot of the example data set of FIG. 7, with labels identified.

### DETAILED DESCRIPTION

Disclosed are systems, methods, and devices for configuring a machine learning tool to classify data elements. Classification may involve attempting to discriminate between categories of elements based on characteristics of the data elements. Labels may be assigned to data elements, indicating categories to which data elements belong or are predicted to belong. Groups of data elements having the same label may be referred to as classes. Data elements may be represented as points within a geometric space referred to as feature space, with each coordinate representing a characteristic of the data elements. Groups of data elements within the same region in feature space may be referred to as clusters.

To cluster and classify unlabeled data elements, the disclosed systems, methods, and devices first identify a small subset of data elements in the data set that are likely to be strongly representative of a cluster to which they belong. Such data elements are hereinafter referred to as “representatives”. This subset of data elements may be manually or automatically labeled. The labeled data elements may then be used to sort (e.g. cluster or classify) unlabeled data elements.

Data elements that are selected for labeling are those that are likely to be strongly representative data elements of the cluster to which they belong. Thus, a large data set may be successfully classified with only a relatively small portion of the data elements being labeled manually. In contrast, if a random sample of data elements was selected for manual labeling, some of those data elements may be less predictive of the cluster to which they belong than the representatives, and therefore, classification may be less accurate.

The inventors have found that labeling of representative data elements chosen as described herein and propagation of labels as described herein provides increased accuracy relative to choosing random points to be labeled and propagating labels from those points.

Accordingly, systems, methods, and devices disclosed herein may be particularly well-suited for classifying data when the data available is a large unlabeled data set.

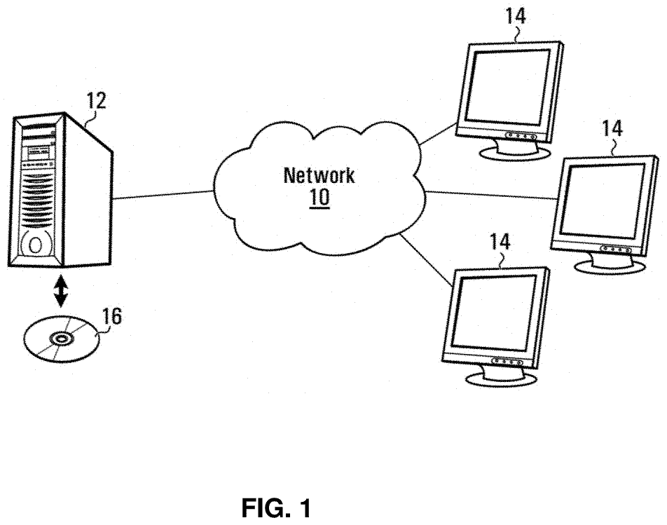

FIG. 1 illustrates a computer network 10, a network connected computing device 12, and network connected computing devices 14 exemplary of an embodiment. As will become apparent, computing device 12 includes software under control of which the computing device is configured to cluster or classify data elements. Computing device 12 may be in communication with other computing devices such as computing devices 14 through computer network 10. Network 10 may be the public Internet, but could also be another network such as a private intranet. Computing devices 14 are network connected devices used to access data and services from computing device 12 and to provide data and services to computing device 12.

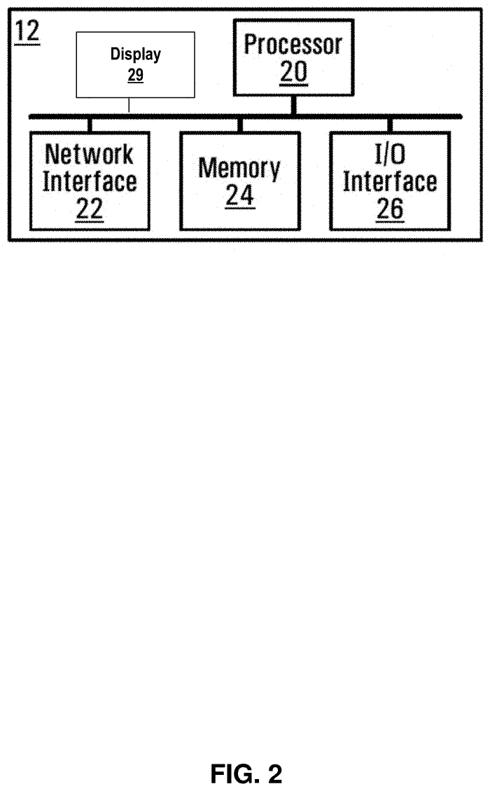

FIG. 2 is high-level block diagram of computing device 12. Computing device 12 includes one or more processors 20, a display 29, network interface 22, a suitable combination of persistent storage memory 24, random-access memory and read-only memory, and one or more I/O interfaces 26. Processor 20 may be an Intel x86, ARM processor, or the like. Network interface 22 connects device 12 to network 10. Memory 24 may be organized using a conventional filesystem, controlled and administered by an operating system governing overall operation of device 12. Device 12 may include input and output devices connected to device 12 by one or more I/O interfaces 26. These peripherals may include a keyboard and mouse. These peripherals may also include devices usable to load software to be executed at device 12 into memory 24 from a computer readable medium, such as computer readable medium 16 (FIG. 1).

Device 12 may store one or more unlabeled data sets in memory 24 for classification, for example in a persistent data store. Each data set in memory 24 has a plurality of data elements. Each data element in a data set may be described in terms of a number of characteristics associated with the data element.

As will be explained further, data elements in each data set may be capable of grouping into clusters. In other words, subsets of the data elements in the data set share similar characteristics with one another, and therefore may be considered to belong to a common cluster.

By way of example, if each data element is an email message, each data element may be characterized by features, such as the date of the email, whether a reply was sent, whether the email includes a specific phrase, the email address of the sender, the domain associated with the email address of the sender, the email address(es) of the recipient(s), the subject line of the email, whether an attachment was enclosed, and so forth. Based on these characteristics, the data elements may be clustered in feature space. These clusters may be predictive for labeling whether the email represented by that data element is likely to be a high risk email for misappropriation of confidential information or likely to be a low risk email for such misappropriation. Alternatively, the data elements may also be labeled, for example, based on whether the email represented by that data element is likely to be a high risk email for including a phishing attack or likely to be a low risk email for including a phishing attack.

Each data set may have several clusters of data elements; such that a first subset of data elements in the data set belongs to a first cluster, a second subset of data elements in the data set belongs to a second cluster, and so forth. The number of data elements in each subset and the number of clusters may vary for each data set. Further, clusters of the same data set may have different numbers of data elements associated therewith (so, for example, 200 data elements may belong to a first example cluster and 2000 data elements may belong to a second example cluster of the same data set). Further, one or more data elements in the data set may not belong to any cluster and may be referred to as an outlier(s).

The number of data elements in each data set may be a relatively large number, such that manual classification would be time-consuming, error-prone, costly and impractical.

The data elements in the data set may initially be completely unlabeled or partially labeled. Further, the number and categories of clusters in a data set may both initially be unknown.

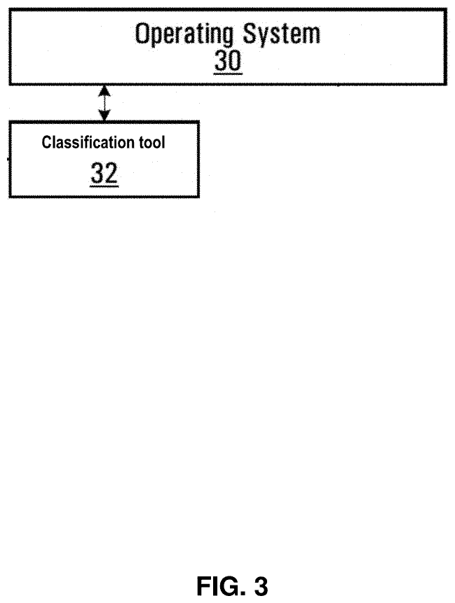

Device 12 may also store in memory 24 software code for sorting (e.g. clustering or classifying) the data elements of the data set into clusters and applying labels to identify the clusters or classifications associated with the clusters. As used herein, a “cluster” refers to a group of data elements and a “class” refers to a category which may be associated with a cluster, e.g. “spam”. FIG. 3 illustrates a simplified organization of example software components stored within memory 24 of device 12. The software components include operating system (OS) software 30 and classification tool 32. Device 12 executes these software components to adapt it to operate in manners of embodiments, as detailed below.

OS software 30 may, for example, be a Unix-based operating system (e.g., Linux, FreeBSD, Solaris, Mac OS X, etc.), a Microsoft Windows operating system or the like. OS software 30 allows classification tool 32 to access processor 20, network interface 22, memory 24, and one or more I/O interfaces 26 of server 12. OS software 30 may include a network stack to allow device 12 to communicate with other computing devices, such as computing devices 14, through network interface 22.

Classification tool 32 adapts computing device 12, in combination with OS software 30 to function in manners exemplary of embodiments, as detailed below. Under control of classification tool 32, computing device 12 may receive a vectorized unlabeled data set (which may be stored in memory 24), classify and label the data set to generate a labeled data set, and store the labeled data set in memory 24. Classification tool 32 may provide the labeled data set to a classifier in order to train a model to classify additional unlabeled data elements.

Classification tool 32 may, in some embodiments, also cluster data elements in a data set, to identify outliers in a data set, as will be explained further.

Further, as will be apparent, users of device 12 or devices 14 may interact with classification tool 32, using a user-input device, to provide labels for some data elements of a data set (usually labels are provided only for a limited number of data elements in the data set).

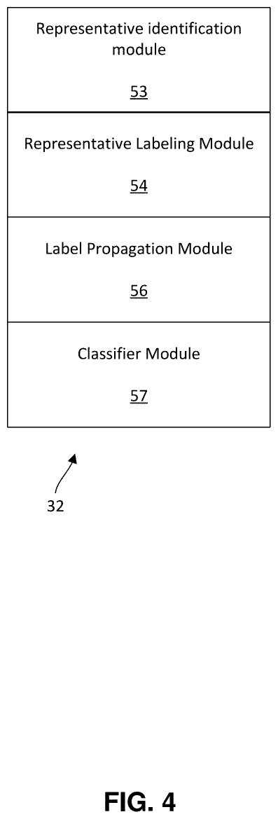

In the embodiment depicted in FIG. 4, classification tool 32 includes a representative identification module 53, a representative labeling module 54, a label propagation module 56, and a classification module 57. These modules may be written using any suitable computing language such as C, C++, C #, Perl, Python, JavaScript, Java, Visual Basic or the like. These modules may be in the form of executable applications, scripts, or statically or dynamically linkable libraries. The function of each of these modules is detailed below.

As noted, classification tool 32 is configured to receive an input data set that has been vectorized. Vectorization includes methods for generating and quantifying characteristics of data elements of a data set into a set of numeral values, each representing a corresponding feature. For example, the email address of the sender (and other non-numerical characteristics) may be encoded to generate a numerical value, via hashing, one-hot encoding or a similar method. Similarly, the value “1” may be used to indicate that an email message has an attachment, and the value “0” may be used to indicate that an email message has no attachment. Each quantifiable characteristic of a data element may be referred to as a “feature”. Thus, each numerical value may represent a feature of a data element. Classification tool 32 may use the values for the features to classify the data.

Representative identification module 53 (hereinafter, “RI module 53”) determines representative elements. The representative elements are a small subset of data elements in a data set. Each representative element may correspond to a cluster of data elements in the data set. The selected data elements are likely to be strongly representative data elements of the cluster to which they belong. Each representative is likely to be positioned in the feature space closer to the centroid of the cluster to which it belongs, compared to other data elements of that cluster.

In one embodiment, RI module 53 selects the primary data elements based on proximity of the primary data elements to neighboring data elements within the feature space.

In one embodiment, RI module 53 may select representatives by determining the closest neighbors for each data element in the feature space. A threshold number of neighbors may be determined. The threshold number may be referred to as k_max, which may be received by RI module 53 as a parameter, where k_max is an integer greater than or equal to 1. To determine the closest neighbors to a data element in the feature space, RI module 53 may first compute the distance between each two data elements in the feature space, for example, by computing the Euclidean distance between the data elements in the feature space, or by using other suitable formulas.

After determining the closest neighbors to a data element in the feature space, RI module 53 may then compute mutuality scores and a cluster score for each data element. Cluster scores are a representation of the extent to which individual data elements lie within a cluster. In an example, cluster scores may be based on mutuality scores, namely, scores indicating for each data element the proportion of nearest neighbors for which the data element is also a nearest neighbor. As used herein, data elements which are among one another's closest neighbors are referred to as mutual neighbors. Therefore, the mutuality score for a given value of k represents the proportion of mutual neighbors among that data element's closest k neighbors. Specifically, the k-th mutuality score for a particular data element is the proportion of that data element's k nearest neighbors for which the data element is also a k nearest neighbor (referred to as mutual neighbors). As an example, if a data element has a mutual neighbor relationship with all of its closest k neighbors, its k-th mutuality score is equal to “1.0”.

A mutuality score may be computed for multiple values of k in a pre-defined range which can then be used to compute the area under the curve (AUC) for the plot of all mutuality scores vs. k. In an example, the cluster score is equal to the total AUC of all mutuality scores of a single data element from k_min to k_max. RI module 53 identifies as representatives those data elements that have k_max mutuality score greater than ½, have cluster scores greater than the cluster score of all of their k_max closest neighbors, and have no mutual neighbors who have already been identified as representatives. In other words, representatives are data elements that have a mutual neighbor relationship with more than a minimum proportion (e.g. half) of the k_max closest data elements to that data element in the feature space and a cluster score which is greater than cluster score of all of the k_max closest data elements. Representatives, having high cluster scores, are thus likely to be close to neighboring elements in the same cluster, meaning that they have like features.

The number of representatives may exceed the number of clusters. For example, if 100 representatives are labeled, they may be identified as belonging to less than 100 distinct clusters. In some cases, the number of representatives identified by RI module 53 is around 1 to 2 times the number of clusters. Therefore, there may be multiple representatives that belong to the same cluster. In data sets where the data elements are not well clustered, or if k_max is set too low, the number of representatives identified by RI module 53 may be a relatively large number. These parameters may be changed to adjust the number of representatives identified in the dataset.

The number of representatives identified may vary inversely with the value of k_max. In data sets with a large number of data elements, the number of primary data elements may be a relatively large number. Accordingly, in some embodiments, RI module 53 may iteratively repeat the process of identifying primary data elements. Each iteration of the process may use the primary data elements identified in the previous iteration as the input data set and identify primary data elements within that input data set. This process may be repeated until a target number of primary data elements is identified. For example, the target may be set such that only 1,000 data elements are selected from 1,000,000 data elements to be primary data elements.

RI module 53 may provide a list identifying representative data elements to representative labeling module 54. Labels may then be assigned to the representatives. Depending on the use case, labels for representative elements may be automatically or manually assigned by a user using a user input device.

In one embodiment, the list of representatives identified for manual labeling may be sent to devices 14, over network 10 for manual labeling, e.g., using a crowdsourcing platform. A number of users of devices 14 may label the representatives, and the labels associated with each representative may be sent to device 12 over network 10.

Alternatively, representative labeling module 54 may automatically label each representative as belonging to its own cluster. Classification tool 32 may label the representatives using generic labels such as “cluster001”, “cluster002”, and so forth. This can be used to distinguish and identify the number of clusters present in the data set. These generic labels may later be assigned real labels manually, as will be shown.

Label propagation module 56 propagates the labels of each labeled data element, beginning with the representatives, to its unlabeled neighboring data elements in the feature space to generate a labeled data set. For each labeled data element, label propagation module 56 selects a threshold number of unlabeled data elements in order of proximity and propagates the label to the selected unlabeled data elements. The threshold number may be referred to as the propagation influence. In some examples, the propagation influence is equal to k_max. This process continues until the k_max closest neighbors of every newly labeled point are labeled. Some data elements may remain unlabeled, namely those that are not among the k_max closest neighbors of any labelled data element. The unlabeled points may be considered outliers. As will be apparent, the likelihood and number of outliers may vary with the value of k_max. That is, larger values of k_max are likely to lead to fewer outliers in a given data set.

As the value of k_max increases, each labeled data element will influence the labels of more of its neighbors. Ideally, the value of k_max is less than or equal to the size of the smallest cluster. Since this value is often unknown, k_max is generally no more than the size of the data set divided by the number of classes.

In some embodiments, labeling modules 54, 56 communicate with classification module 57 and provide the labeled data set to classification module 57 in order to train a classifier. Additional unlabeled data elements that have a vector representation in the feature space of the labeled data set can be classified using the model trained in classification module 57. In this regard, classification module 57 may implement any one of a number of classifiers, including, a correlation model, a decision tree classifier, a logistic regression model, or other model.

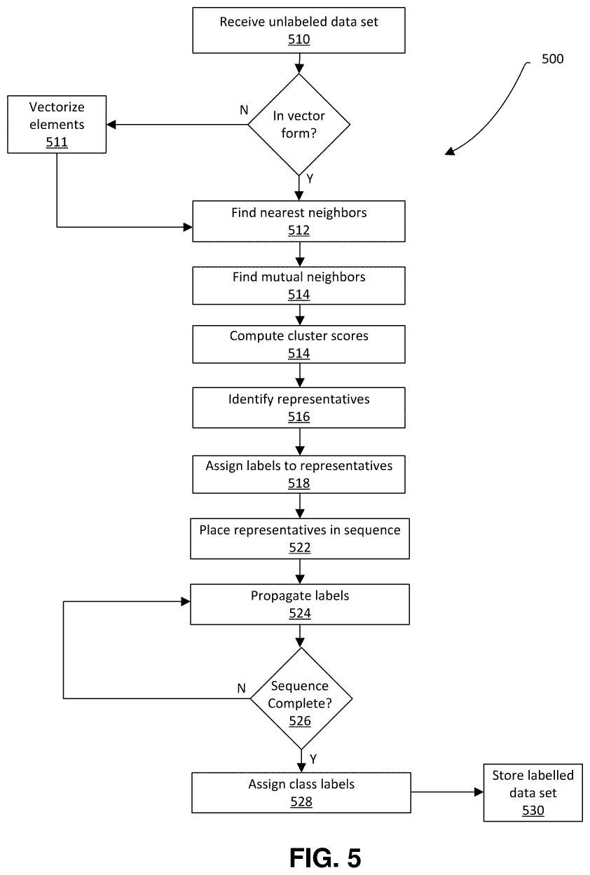

The operation of classification tool 32 is further described with reference to the example flowcharts and examples illustrated in FIGS. 5-16.

FIG. 5 illustrates an example method 500 of classifying data elements. Instructions for implementing method 500 are stored in memory 24, as part of classification tool 32. Method 500 may be performed by processor 20 of the computing device 12, operating under control of instructions provided by classification tool 32. Blocks of method 500 may be performed by processor 20 which may perform additional or fewer steps as part of the method.

At 510, classification tool 32 receives an unlabeled data set having a plurality of data elements for classification. The unlabeled data set may be stored in memory 24 and retrieved by classification tool 32. The unlabeled data set may be sent to computing device 12 via network 10 from a computing device 14, and upon receipt of the unlabeled data set, computing device 12 may save the unlabeled data set in memory 24.

In some examples, the received data set is vectorized, in which case classification tool proceeds to block 512. Otherwise, at 511, classification tool 32 identifies a vector representing each of the data elements of the unlabeled data set in the feature space. Each vector includes a set of values corresponding to the features of the respective data elements.

At 512, classification tool 32 identifies the k_max nearest neighbors of each data element and stores them. As noted, nearest neighbors may be identified based on proximity of data elements to one another within the feature space, for example, based on Euclidean distance within the feature space. At 514, the nearest neighbors for the data elements are compared to identify mutual neighbor relationships between data elements. As noted, two data elements are mutual neighbors at a value k if they appear in each other's list of k nearest neighbors. Scores are assigned based on the proportion of mutual neighbor relationships among each data element's k nearest neighbors, for values of k from k_min to k_max.

At 515, cluster scores are computed for the data elements. Cluster scores are based on the proportion of mutual neighbor relationships among each data element's k nearest neighbors, for each value of k. In an example, cluster scores are based on cumulative value of the mutuality scores, e.g., the area under the curve in a plot of mutual neighbor proportion for all values of k.

At 516, classification tool 32 selects from the unlabeled data set representative data elements which represent corresponding clusters of data elements, as described above. A data element is selected as representative if it has more than a threshold proportion of mutual neighbor relationships among its k_max mutual neighbors (e.g., more than half), and if it has the highest cluster score among those k_max mutual neighbors.

In some examples, data elements may be identified as outliers. For example, a data element may be identified as an outlier if it has less than a threshold proportion of mutual neigbor relationships among its k_max mutual neighbors (e.g. less than half) and if it has the lowest cluster score among those mutual neighbors.

At 518, labeling module 54 of classification tool 32 may label each representative as belonging to its own cluster. In some embodiments, generic labels may be automatically assigned by classification tool 32 serve to distinguish clusters from one another. For example, classification tool 32 may automatically assign a random, unique alphanumeric identifier to each cluster.

Labeling of representatives produces a partially labeled data set. The labeled data elements at this stage may include only the representatives, as noted above.

At 522 through 526, label propagation module 56 of classification tool 32 may propagate the labeled representatives received in 518 to sort data elements which remain unlabeled into clusters.

At 522, classification tool 32 places the labeled data elements of the partially labeled data set into a sequence. The sequence may be organized in the form of any data structure that preserves the order of data elements in that data structure, such as a queue. That data structure may be stored temporarily in a buffer within the memory. The sequence is sorted by cluster scores, with the data element with the highest cluster score being placed first in the sequence. Any new data elements added to the sequence are inserted as to retain this order from highest to lowest score. Should there be a tie in cluster score during insertion, the new data element is inserted after the last position of that value in the sequence.

Classification tool 32 may determine the propagation influence for propagating the labels of the labeled data elements. As noted, in an example, the propagation influence is equal to k_max. However, in other embodiments, other integer values may be selected.

Classification tool 32 may then proceed, at 524, to propagate the assigned labels of labeled data elements to unlabeled elements of the data set within the labeled data element's set of mutual neighbors, thereby identifying clusters, as described below. For a given labeled data element, that data element's label is applied to its closest mutual neighbors (if those neighbors are unlabeled), until the number of neighbors to which the label is applied equals the propagation influence (e.g. k_max). In other words, each labeled data element may influence the labels of its unlabeled neighbors. Moreover, because labels are propagated only previously-unlabeled data elements, each element receives the label that is first assigned according to the sequence. Thus, if a data element is within the k_max closest neighbors of multiple representatives, it will be assigned the label of the representative with the higher cluster score, which will be placed earlier in the sequence.

As further data elements are labeled by classification tool 32, those labeled data elements may be also added to the sequence. Accordingly, the data elements in the sequence may change at various stages.

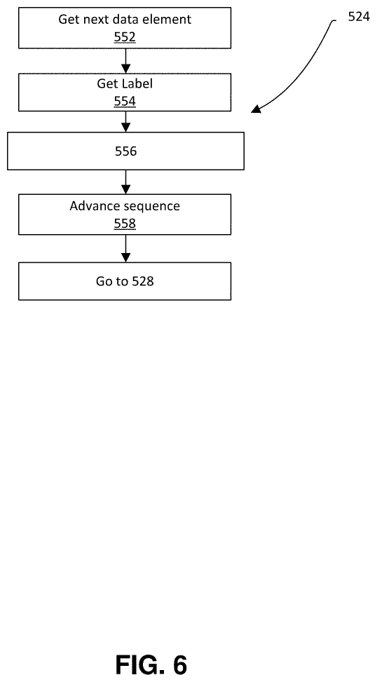

Reference is now made to FIG. 6, which provides additional details of the subroutine 524 of FIG. 5.

At 552, classification tool 32 selects the first data element in the sequence.

At 554, classification tool 32 identifies the retrieved label of the data element from 552.

At 556, classification tool 32 inserts each mutual neighbor of the data element from 552 into the sequence and assigns each mutual neighbor the label from 554. Again, as each mutual neighbor is inserted, the order of the sequence from highest to lowest score is maintained.

At 558, classification tool 32 removes the first data element from 552 from the sequence.

At 526, classification tool 32 determines checks whether the sequence is empty. If it is not, there are additional data elements in the sequence from which labels have not been propagated. In this case, classification tool 32 repeats 524 and at 552, the next data element in the sequence is selected. The flow of subroutine 524 continues until all data elements in the sequence are selected once, then subroutine 524 ends and program flow proceeds to 528 of method 500 (FIG. 5).

In some embodiments, classification tool 32 may repeat the propagation subroutine 524 one or more times. Prior to each re-running of propagation subroutine 524, the representatives may be re-ordered in subroutine 522, to reduce any bias resulting from the arbitrary order of placement of the unlabeled data elements in the sequence. However, as the sequence is always ordered by cluster score, this re-ordering is typically insignificant. The more natively clusterable the data set is the less affect this will have on the final outcome. If re-running of propagation subroutine 524 results in different labels for a given data element, classification tool 32 may select the most frequently-occuring label. For example, if propagation subroutine 524 is run three times, and a particular data element is assigned a first label on two of the runs and a second label on the third run, the first label may be selected. In the event of ties between labels, a tiebreaking algorithm may be used. For example, the first-assigned label among the tied labels may be selected. Alternatively, propagation subroutine 524 may be re-run until ties are eliminated.

At 528, classification module 57 may assign class labels associated with the identified cluster labels. That is, descriptive labels such as “spam” and “promotion” may be associated with the generic cluster labels such as “cluster001” and “cluster002”. Such labeling may be done manually. For example, the representative data elements may be presented to a user for input of a label by the user using a user interface. Labels assigned in this manner may then be assigned to data elements with the same cluster label as the representative. For example, if a user is presented the representative data element from cluster001 and inputs a class label “Spam”, that class label may be copied to all data elements labeled with “cluster001”.

As noted, in some embodiments, labeling of classes may be done remotely over network 10. For example, a user interface and representative data elements may be presented to users at one or more computing devices 14 (FIG. 1), and input received for propagation and storage by computing device 12. In some embodiments, this labeling task may be distributed among multiple users at multiple computing devices 14, which may be referred to as crowd-sourcing.

As shown in FIG. 5, labelling of classes at 528 occurs after propagation of cluster labels at 522-526. However, in some embodiments, class labels may be assigned prior to propagation. In such cases, labels propagated at 522-526 may include class labels instead of or in addition to cluster labels. In other embodiments, cluster labels may be omitted entirely. For example, block 528 may simply replace block 518 in the flow depicted in FIG. 5. Unlabeled representatives may be presented to users and class labels may be directly applied.

Classification tool 32 may store in memory 24, at 530, a single or multiple label in association with each data element to generate a labeled data set.

Optionally, the labeled data set may be used as an input to a machine learning algorithm in order to train a model to classify new data elements. The resulting trained model could be used to classify new data sets with different elements, provided such data sets are capable of representation within the same feature space.

Reference is now made to an application of method 500 to an example data set 600, which is illustrated graphically in FIG. 7. For simplicity, data set 600 includes only nine data elements and each data element only has two features. Since data set 600 has only two features, the data set occupies a 2-dimensional feature space. Classification tool 32 may represent the example data elements of data set 600 graphically in a 2-dimensional graph 610 that represents the feature space, as illustrated in FIG. 7.

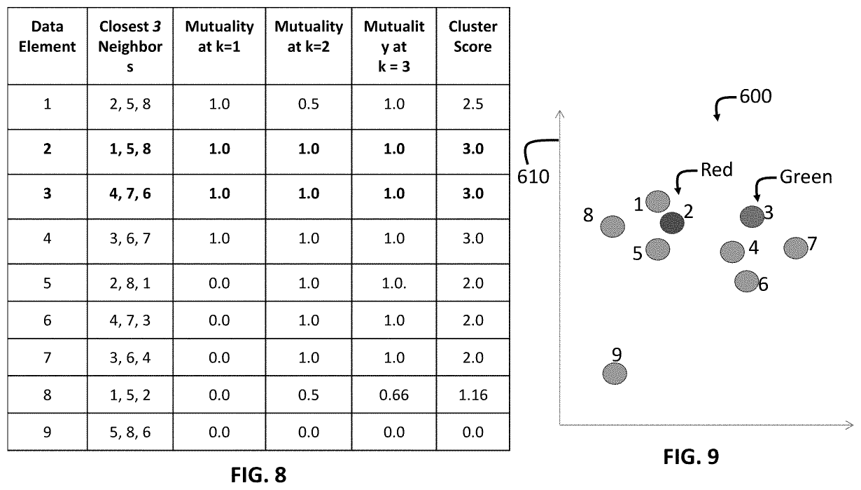

Classification tool 32 may first identify the representatives in data set 600 by computing the cluster score of each data element in the data set. The cluster score of each data element and the closest k_max neighbors for each data element of data set 600 are noted in FIG. 8 for a value of k_max equal to “3”.

Notably, data element “2” of data set 600 has a cluster score of “3.0”. The closest three data elements to data element “2” are data elements “1”, “5”, and “8”. Data element “2” has a mutual neighbor relationship with data element “1” at k=1 and a mutual neighbor relationship with both data elements “1” and “5” at k=2, because data element “2” is one of the closest two data elements to both data element “1” and data element “5” at k=2. It has a mutual neighbor relationship with data elements “1”, “5”, and “8” at k=3. Accordingly, classification tool 32 may identify data element “2” as a representative, since a cluster score of 3.0 is higher than cluster scores of data element “1” at 2.5, data element “5” at 2.0, and data element “8” at 1.16.

Similarly, data element “3” of data set 600 has a cluster score of “3.0”. The closest three data elements to data element “3” are data elements “4”, “7”, and “6”. Data element “3” has a mutual neighbor relationship with both data elements “4” and “7” at k=2 because data element “3” is one of the closest two data elements to both data element “4” and data element “7”. It has a mutual neighbor relationship with data elements “4”, “7”, and “6” at k=3. Accordingly, classification tool 32 may also identify data element “3” as a representative since it is tied for highest score with data element “4” at 3.0, and is higher than data elements “7” and “′6” at 2.0.

Data element “4”, on the other hand, has a cluster score of “3.0” but is not representative. This is because while data element “4” is tied for the highest cluster score with data element “3” and has a higher cluster score than “6” and “7” at 2.0, data element “3” has already been identified as a representative in the previous step, meaning data element “4” cannot also be a representative.

Data element “2”, which was identified as a representative, may be identified to belong to a first cluster and labeled as such. Similarly, data element “3”, which was also identified as a representative, may be identified to belong to a second cluster and labeled as such. Labeling may, for example, be done manually by a user. At this stage, only the data elements “2” and “3” are labeled. In this case, each of the data elements “2” and “3” belongs to a different cluster, with the data element “2” being labeled “Red” and data element “3” being labeled “Green” (FIG. 9).

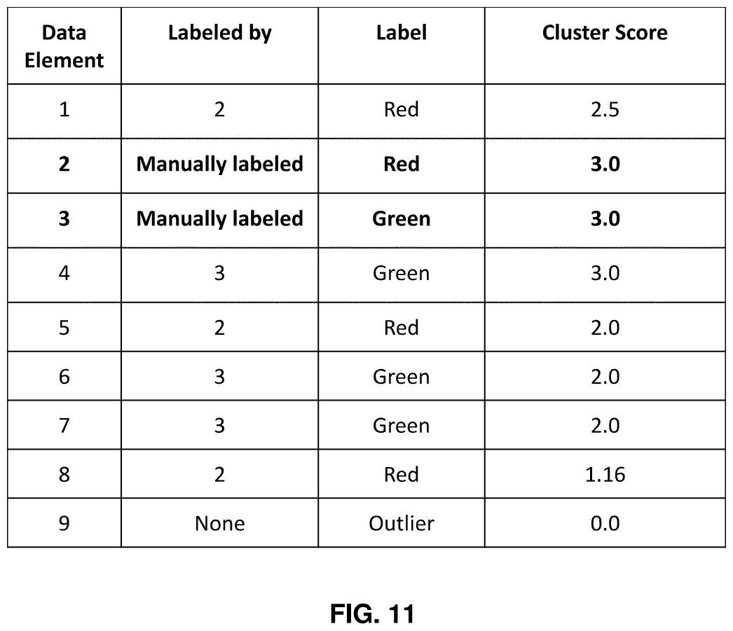

The representatives, “2” and “3”, are then added to sequence 650. Sequence 650 is shown in FIG. 10 at different stages of method 500 (shown as 650a, 650b, 650c, and 650d). Sequence state 650a, shows the sequence as it exists immediately following identification and labeling of representatives, Sequence state 650a has only the representatives, with data element “2” positioned first in the sequence state and data element “3” positioned second in the sequence state.

Classification tool 32 then proceeds to label the remaining data elements. Classification tool 32 selects the first data element in the sequence 650a; i.e. data element “2”. As noted previously, data element “2” of the example data set 600 is associated with a cluster labeled “Red”. Data element “2” has three unlabeled neighbors, data elements “1”, “5”, and “8”. Classification tool 32 associates the label of data element “2” with those three data elements and removes data element “2” from the sequence.

As shown in FIG. 10, in state 650b, classification tool 32 inserts data elements “1”, “5”, and “8” into the sequence.

Classification tool 32 then selects the next data element in the sequence 650b; i.e. data element “3”. As noted previously, data element “3” of the example data set 600 is associated with a cluster labeled “Green”. Data element “3” has three unlabeled mutual neighbors, data elements “4”, “7”, and “6”, its three closest neighbors. Classification tool 32 associates the label of data element “3” with data elements “4”, “7”, and “6”, Classification tool 32 then inserts the data elements “4”, “7”, and “6” to the sequence 650c, as shown in FIG. 10.

Each of data elements “4”, “7” and “6” have cluster scores higher than that of data element “8”. Therefore, as shown in FIG. 10, 650c, classification tool 32 inserts data elements “4”, “7”, and “6” into the sequence ahead of data element “8”, to maintain the order of the sequence from highest cluster score to lowest, as shown in FIG. 8.

Classification tool 32 then again selects the next data element in the sequence 650c; i.e. data element “4”. Data element “4” has no unlabeled mutual neighbors, as all of its mutual neighbors “3”, “6” and “7” have already been in the sequence (see states 650a, 650c).

Classification tool 32 selects the next data element in the sequence, i.e. data element “1” (see state 650d). Data element “1” also has no unlabeled mutual neighbors, as all its mutual neighbors 2, 5 and 8 have been in the sequence (see states 650a, 650b, 650c).

Classification tool 32 thus removes data element “1” from the sequence proceeds to select the new first data element in the sequence; i.e. data element “5”. Data element “5” also has no unlabeled mutual neighbors. This continues until data element “8” is the only data element remaining to be processed. Since all its mutual neighbors have already been added to the sequence, data element “8” is removed from the sequence, and the process completes.

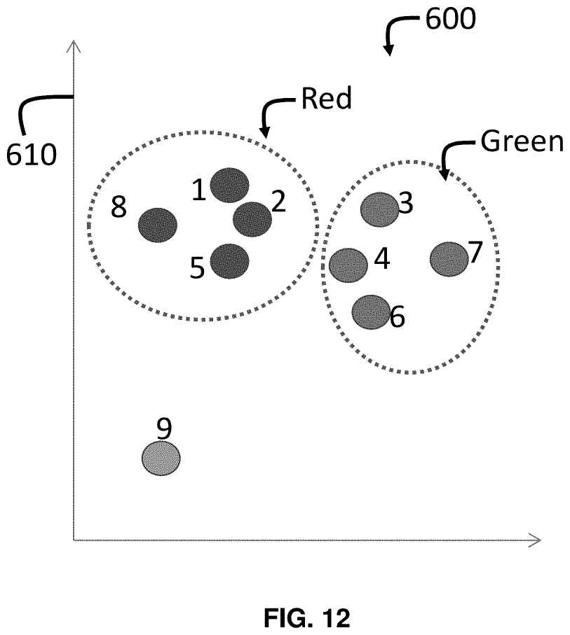

After the process completes, all reachable data elements have been labeled. Data element “9” in data set 600 could not be reached, and hence does not have a label, FIG. 11, 12. Data elements which do not have labels after the propagation process is complete may be considered outliers. Data element's “1”, “2”, “5”, “8” have been labeled “Red” while data elements “3”, “4”, “6”, “7” have been labeled “Green”. In some instances, unreached data elements may be considered as outliers. In the depicted example, data element “9” meets the above-referenced definition of outlier, namely, a k_max mutuality score below 0.5 and having the lowest cluster score among its k_max closest mutual neighbors.

As depicted, each data element is removed from the sequence after processing. Accordingly, each iteration begins with the first element in the sequence. Alternatively, data elements may be maintained in the sequence, and classification tool 32 may track its position in the sequence.

As described above, an input data set is received by classification tool 32 in vectorized form, i.e. along with feature vectors representing the data elements in a feature space. However, in some embodiments, classification tool 32 may further include a vectorization module for defining feature vectors of input data elements. Such a vectorizer may use any suitable vectorization algorithm.

In some embodiments, the disclosed apparatus and methods may be used for multiple labeling, wherein one or more labels may be assigned to each data element. In such embodiments, labels may be propagated to all of the k_max closest neighbors of each data element, rather than to only unlabeled neighbors.

A confidence level may be assigned along with the label. In an example, the confidence level is defined as the product of the confidence level of the preceding element from which the label is inherited, and the cluster score of the data element to which the label is being applied. Representatives may be assigned a confidence level of 1.0. Thus, if a representative passes a label to a data element having a cluster score of 0.8, the data element will be assigned the label with a confidence of 0.8. If that data element passes the same label to a subsequent element with cluster score 0.5, the subsequent data element will have a confidence 0.4. If the same label is passed to a data element from multiple preceding elements, the associated confidence levels may be averaged.

Method 500 may be used to classify any number of example data sets.

By way of example, for a series of emails, emails may be represented by feature vectors having m dimensions. Suitable features for classifying emails may include any of the following features: the date of the email, whether a reply was sent, whether the email includes a specific phrase, the email address of the sender, the domain associated with the email address of the sender, the email address(es) of the recipient(s), the subject line of the email, whether an attachment was enclosed, and so forth. A hash value may be computed for non-numerical based features (such as the subject line) so that a discrete numeral value can be used to represent that feature

In an example, method 500 may be used to classify emails for characteristics such as fraud, sentiment or topic detection or recognition, or spam detection. Emails may be classified using features such as text, number of words, number of characters, timestamps, recipient/sender addresses and thread info.

In another example, method 500 may be used to classify social media data, for example, to classify public sentiment for market research, customer segmentation or sentiment detection. Social media data may be classified using features such as text, number of words, number of characters, timestamps, recipient/sender addresses, thread info, and images.

In another example, method 500 may be used to classify press releases, for example, for fraud detection, sentiment detection and topic recognition. Press releases may be classified, for example, based on text, number of words, number of characters, timestamps and market data.

In another example, method 500 may be used to classify transaction logs, for example, for fraud detection, sentiment detection and topic recognition. Transaction logs may be classified, for example, based on text, transaction amounts, recipient/sender info, timestamps, transaction types, and history.

In another example, method 500 may be used to analyze support logs, such as phone support logs, for example, to recognize user intent and respond appropriately. Support logs may be classified, for example, based on text, number of words, number of characters, and timestamps.

In another example, method 500 may be used to analyze financial statements, such to predict regulatory treatment. Financial statements may be classified, for example, based on text, number of words, number of characters, and market data.

In another example, method 500 may be used to analyze medical or test records, such for diagnostic purposes or gene sequence analysis. Such records may be classified, for example, based on genetic sequences, physical property measurements, and quantity/quality information.

In another example, method 500 may be used to analyze ecological information, such as for species identification. Ecological data may be classified, for example, based on genetic sequences, physical property measurements, and quantity/quality information.

In another example, method 500 may be used to analyze images, for example, for facial or object recognition. Images may be classified, for example, based on pixel values such as RGB/CMYK values of pixels.

Additional characteristics may be used for classification in any of the above examples. In addition, data may be classified into additional categories or types of categories. Moreover, systems and methods herein may be used to analyze and classify other types of data.

Of course, the above described embodiments are intended to be illustrative only and in no way limiting. The described embodiments are susceptible to many modifications of form, arrangement of parts, details and order of operation. For example, software (or components thereof) described at computing device 12 may be hosted at several devices. Software implemented in the modules described above could be implemented using more or fewer modules. The invention is intended to encompass all such modification within its scope, as defined by the claims.

1. A method for classifying data elements, the method being executed by a processor coupled to a computer memory, the method comprising:
receiving unlabeled data set, the unlabeled data set having a plurality of data elements, each represented in a feature space comprising a set of values corresponding to the features of the respective data element;
selecting from the unlabeled data set, one or more representative data elements to represent corresponding clusters of data elements, the selecting based on proximity of the representative data elements to neighboring data elements within the feature space;
labeling the representative data elements to identify the corresponding clusters; and
for each one of a sequence of data elements, beginning with said representative data elements:
selecting a labeled data element in the sequence;
selecting unlabeled data elements neighboring that labeled data element;
copying a label from that labeled data element to the selected unlabeled data elements; and
adding the selected unlabeled data elements to the sequence.

2. The method of claim 1, wherein selecting the one or more representative data elements comprises assigning a mutuality score to each data element representing the portion of mutual neighbors among a threshold ranking of that data element's closest neighbors, wherein data elements are mutual neighbors if they are each among one another's closest neighbors.

3. The method of claim 2, wherein selecting the one or more representative data elements comprises assigning a cluster score to each data element, representing a combination of mutuality scores at multiple threshold ranking values.

4. The method of claim 3, wherein said sequence is ordered according to cluster score.

5. The method of claim 3, wherein selecting the one or more representative data elements comprises selecting data elements with a cluster score above a defined threshold.

6. The method of claim 5, wherein selecting the one or more representative data elements comprises selecting data elements having cluster scores higher than the cluster scores of their mutual neighbors.

7. The method of claim 1, further comprising receiving labels for each one of the representatives from a user input device, each label representing a class.

8. The method of claim 1, wherein the selecting unlabeled data elements comprises selecting data elements that are within a threshold proximity of the selected labeled one of the data elements.

9. The method of claim 7, wherein the threshold proximity is defined as a threshold rank of the closest neighboring data elements.

10. The method of claim 3, comprising identifying one or more data elements as outliers based on proximity to neighboring data elements within said feature space.

11. The method of claim 11, wherein identifying said one or more outliers comprises identifying data elements having a mutuality score below a threshold value.

12. The method of claim 10, wherein selecting said one or more outliers comprises selecting data elements having cluster scores lower than the cluster scores of their mutual neighbors.

13. A computing system for classifying data elements comprising:
a memory storing an unlabeled data set, the unlabeled data set having a plurality of data elements represented in a feature space, and storing executable instructions; and
at least one processor configured to execute the executable instructions, the executable instructions causing the processor to:
generate a labeled data set by:
selecting from the unlabeled data set, one or more representative data elements to represent corresponding clusters of data elements, the selecting based on proximity of the representative data elements to neighboring data elements within the feature space;
labeling the representative data elements to identify the corresponding clusters; and
for each one of a sequence of data elements, beginning with said representative data elements:
selecting a labeled data element in the sequence;
selecting unlabeled data elements neighboring that labeled data element;
copying a label from that labeled data element to the selected unlabeled data elements; and
adding the selected unlabeled data elements to the sequence.

14. The computing system of claim 13, wherein selecting the one or more representative data elements comprises assigning a mutuality score to each data element representing the portion of mutual neighbors among a threshold ranking of that data element's closest neighbors, wherein data elements are mutual neighbors if they are each among one another's closest neighbors.

15. The computing system of claim 14, wherein selecting the one or more representative data elements comprises assigning a cluster score to each data element, representing a combination of mutuality scores at multiple threshold ranking values.

16. The computing system of claim 15, wherein said instructions cause said processor to order said sequence according to cluster score.

17. The computing system of claim 15, wherein selecting one or more representative data elements comprises selecting data elements with a cluster score above a defined threshold.

18. The computing system of claim 17, wherein selecting the one or more representative data elements comprises selecting data elements having cluster scores higher than the cluster scores of their mutual neighbors.

19. The computing system of claim 13, wherein said instructions cause said processor to receive labels for each one of the representatives from a user input device, each label representing a class.

20. The computing system of claim 13, wherein the selecting unlabeled data elements comprises selecting data elements that are within a threshold proximity of the selected labeled one of the data elements.

21. The computing system of claim 20, wherein the threshold proximity is defined as a threshold rank of the closest neighboring data elements.

22. The computing system of claim 15, wherein said instructions cause said processor to identify one or more data elements as outliers based on proximity to neighboring data elements within said feature space.

23. The computing system of claim 22, wherein said instructions cause said processor to identify said one or more outliers by identifying data elements having a mutuality score below a threshold value.

24. The computing system of claim 23, wherein said instructions cause said processor to select said one or more outliers by selecting data elements having cluster scores lower than the cluster scores of their mutual neighbors.

25. A computing device comprising:
a memory storing an unlabeled data set, the unlabeled data set having a plurality of data elements represented in a feature space;
a data element selector to select one or more representative data elements to represent corresponding clusters of data elements, based on proximity of the representative data elements to neighboring data elements within the feature space from the unlabeled data set;
a label generator to label the representative data elements to identify the corresponding clusters, and to propagate labels from labeled data elements in the data set to unlabeled data elements in the data set by,
for each one of a sequence of data elements, beginning with said representative data elements:
selecting a labeled data element in the sequence;
selecting unlabeled data elements neighboring that labeled data element;
copying a label from that labeled data element to the selected unlabeled data elements; and
adding the selected unlabeled data elements to the sequence.

26. The computing device of claim 25, wherein the data element selector is to select the one or more representative data elements by assigning a mutuality score to each data element representing the portion of mutual neighbors among a threshold ranking of that data element's closest neighbors, wherein data elements are mutual neighbors if they are each among one another's closest neighbors.

27. The computing device of claim 26, wherein the data element selector is to select the one or more representative data elements by assigning a cluster score to each data element, representing a combination of mutuality scores at multiple threshold ranking values.

28. The computing device of claim 27, wherein the label generator is to order said sequence according to cluster score.

29. The computing device of claim 27, wherein the data element selector is to select the one or more representative data elements by selecting data elements with a cluster score above a defined value.

30. The computing device of claim 29, wherein the data element selector is to select one or more representative data elements by selecting data elements having cluster scores higher than cluster scores of their mutual neighbors.

31. The computing device of claim 26, further comprising a user interface for receiving labels for each one of the representatives from, a user input device, each label representing a class.

32. The computing device of claim 26, the label generator is to select unlabeled data elements by selecting data elements that are within a threshold proximity of the selected labeled one of the data elements.

33. The computing device of claim 32, wherein the threshold proximity is defined as a threshold rank of the closest neighboring data elements.

34. The computing device of claim 28, wherein said data element selector is to identify one or more data elements as outliers based on proximity to neighboring data elements within said feature space.

35. The computing device of claim 34, wherein said said data element selector is to identify said one or more outliers by identifying data elements having a mutuality score below a threshold value.

36. The computing device of claim 35, wherein said data element selector is to select said one or more outliers by selecting data elements having cluster scores lower than the cluster scores of their mutual neighbors.
